(19) United States
(12) Patent Application Publication
(10) Pub. No.: US 2006/0237202 A1
(43) Pub. Date: Oct. 26, 2006

(54) Three point mount material packer

(76) Inventors: Clauriste H. Byles SR., Many, LA (US); Clauriste H. Byles JR., Many, LA (US)

Correspondence Address: Rodney B. Jordan, 700 N. Nolan Trace, Florien, LA, 71429, US

(21) Appl. No.: 11/115,525

(22) Filed: Apr. 26, 2005

(51) Int. Cl. A01B 5/00

(52) U.S. Cl. 172/518

(57) ABSTRACT

A roller type apparatus for packing roadbed materials suitable for mounting on a tractor type three point hitch also having a bar for scraping materials from the roller and spray nozzles for moistening the roller.

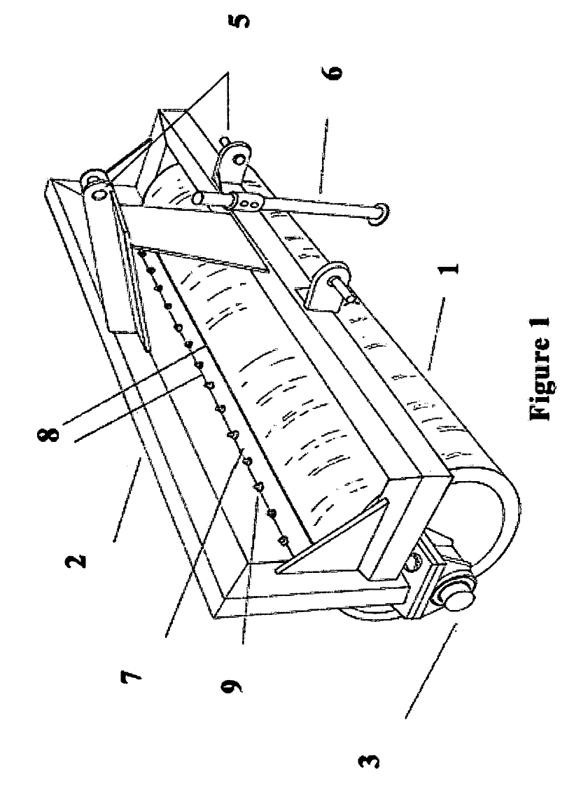

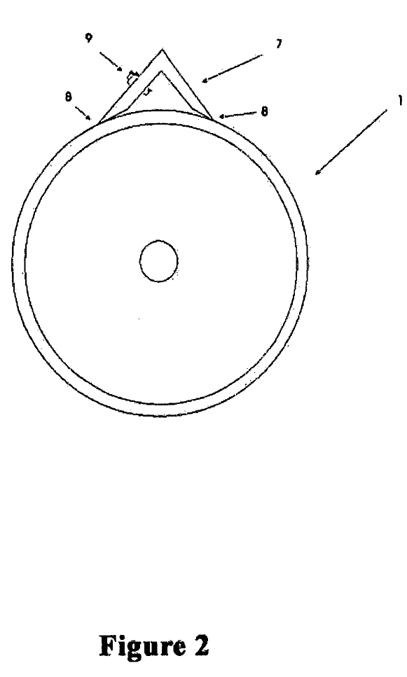

### BACKGROUND OF THE INVENTION

The invention as described herein relates to an apparatus for packing roadbed materials and more specifically materials being used in the common practice of pothole repair. As the price of constructing new roads and streets continues to rise rapidly is becomes more and more important to be able to quickly, efficiently and economically refurbish roadbeds that have fallen into disrepair. The most common malady suffered by streets is what is commonly called the pothole. Potholes are generally filled by asphalt or some similar type material and then packed into place tightly, usually by a roller-packer. Filling these holes presents certain problems that the present invention solves. Two such problems are the sticking of the material being packed into the hole to the roller rather than the roadbed and transporting the roller-packer to the site where it is to be used. In order to pack the materials into the pothole the roller-packer must be extremely heavy, using its weight to exert the force on the material being compressed. This necessary weight makes it unacceptable to simply pull the roller-packer to the site where it is needed. It is necessary to load the packer onto a trailer and then offload it at the site where the pothole exists. Potholes are notorious for popping up in remote solitary places making it often impractical to transport the machinery to the location. The pothole is thus left unfilled and therefore grows in diameter thus exacerbating the problem. In addition to this, the wider the diameter of the pothole the more the tendency of the material being packed to stick to the packer. Material that has adhered to the packer is either deposited upon an undamaged part of the road surface, creating a bump or pressed into the fresh material causing a dent in the new surface. These problems are addressed and solved by the invention as described herein.

### DESCRIPTION OF THE PRIOR ART

The roller-packer is of course a common piece of equipment within the inventories of street maintenance units everywhere, however previously used roller-packers are pulled by a tractor by hooking the tractor to a trailer hitch type appendage projecting from the front of the roller. This meant that the equipment being used had to be loaded and unloaded at the site. This required additional equipment to be carried to the site for this purpose. It was also time consuming. Also previously used roller-packers were simply heavy cylinders to be rolled across material being applied with no proper provision for applying no-stick materials to the roller and for removing materials, which had adhered to the roller.

### SUMMARY OF THE INVENTION

The Three Point Mount roller-packer as described herein comprises generally a cylindrically shaped roller of suitable weight for packing materials having a hub and bearing assembly at each end. This hub and bearing assembly is affixed to a frame adjacent to the roller rather than to a bracket leading to a trailer hitch type arrangement as in previously existing roller-packers. A three-point hitch setup is affixed to the frame suitably so that the apparatus can be mounted to a common three-point hook up used by most tractors. Thus the roller-packer can be raised from the roadbed and transported by the tractor that will power the operation at the site where the roller-packer will be employed.

Also affixed to and a part of the frame is a bar that is suitably positioned and shaped so as to remove materials from the roller as it rolls beneath it. Positioned along this scraper bar is a plurality of spray nozzles. These spray nozzles deliver water, oil or some other such material evenly to the roller in order to prevent material from adhering to it.

### BRIEF DESCRIPTION OF THE DRAWINGS

Figure one is a prospective view of the Three Point Mount Material Packer.

Figure two is a cross sectional view of the scraper bar and roller.

### DETAILED DESCRIPTION

Referring to figure one it can be seen that a roller 1 is affixed to a frame 2 by bearings 3, located on a shaft 4 at either end of roller 1. Three-point hitch arrangement 5 is affixed to frame 2 so that the roller-packer can be hitched to a tractor for both towing and lifting. Stand 6 is attached to frame 2 so that three-point hitch arrangement 5 is held in place for mounting when the roller-packer is not in use. Scraper bar 7 is affixed at each end to frame 2 so that it runs laterally along and adjacent to roller 1.

Referring to figure two it can be seen that the surface of roller 1 scrapes against the scraping edge 8 of scraper bar 7 thus removing material that might adhere to roller 1. Spray nozzles 9 are affixed to scraper bar 7. They are arrayed along the entire length of scraper bar 7 so as to deliver fluid to the surface of roller 1 during operation. The fluid is applied evenly between scraping edges 8. Spray nozzles 9 are protected by being partially located beneath scraper bar 7.

I Claim:

1. An apparatus to be pulled by a tractor for packing roadbed materials having a roller, a shaft at either end of said roller, a bearing on both said shafts comprising:
a. a means for lifting, transporting and pulling said apparatus
b. a means for cleaning said materials from said roller, and
c. a means for preventing said materials from adhering to said roller.

2. An apparatus as described in claim 1, wherein said means for lifting, transporting and pulling said apparatus comprises a tractor type three point hitch mounting apparatus.

3. An apparatus as described in claim 2, wherein said three point hitch is mounted to a frame, said frame further comprising a vertically positioned inverted U shaped member, said vertically positioned member having a horizontal mid section positioned above and horizontal to said roller and two downward projecting sides, each side having a lower terminal end, said terminal ends being connected to said bearings and a horizontally positioned U shaped member, said horizontally positioned member having a forward cross member having two ends and a backward projecting member at both ends of said forward cross member, said backward projecting members each having a terminal end, said terminal ends being rigidly affixed to said downward projecting sides of said vertically positioned member, said three point hitch being affixed to said frame.

4. An apparatus as described in claim 3, wherein said horizontal mid section further comprises a midpoint, said midpoint lying midway along the length of said horizontal mid section and wherein said forward cross member further comprises a midpoint, said three point hitch further comprising a third arm connecter and two lift connecters, said third arm connected being connected to said midpoint of said horizontal mid section and being braced to said midpoint of said forward cross member by said brace, said lift connecters being affixed to and positioned along the length of said forward cross member, each said lift connecter being positioned on either side of said midpoint of said forward cross member at a distance from each other so as to accommodate being connected to a standard tractor three point hitch.

5. An apparatus as described in claim 4, wherein said apparatus further comprises a jack stand, said jack stand having a stationary housing and a support traversing said housing, said housing being affixed to said midpoint of said forward cross member so as to adjust the height of said three point hitch and to support said frame while said apparatus is not in use.

6. An apparatus as described in claim 5 wherein said frame further comprises a scraper bar, said scraper bar having two ends, each said end being rigidly affixed to said downward projecting sides of said vertically positioned member in a position horizontal and adjacent to said roller
